(19) United States
(12) Patent Application Publication
(10) Pub. No.: US 2026/0065924 A1
(43) Pub. Date: Mar. 5, 2026

(54) HEART SOUND SIGNAL QUALITY ASSESSMENT METHOD, ELECTRONIC DEVICE AND READABLE STORAGE MEDIUM

(71) Applicants: SOUTHEAST UNIVERSITY, Nanjing (CN); GOERTEK INC., Weifang (CN)

(72) Inventors: Chengyu LIU, Weifang (CN); Li LING, Weifang (CN); Yumin LI, Weifang (CN); Yaocheng LIU, Weifang (CN); Junjie PAN, Weifang (CN); Huan LI, Weifang (CN); Yanan ZHOU, Weifang (CN); Chenxi YANG, Weifang (CN); Jianging LI, Weifang (CN)

(21) Appl. No.: 19/380,267

(22) Filed: Nov. 5, 2025

Related U.S. Application Data
(63) Continuation of application No. PCT/CN2024/132579, filed on Nov. 18, 2024.

(30) Foreign Application Priority Data
Apr. 15, 2024 (CN) 202410451061.3

(51) Int. Cl. G10L 25/48; G10L 25/09; G10L 25/21

(52) U.S. Cl. CPC G10L 25/48; G10L 25/09; G10L 25/21

(57) ABSTRACT

A heart sound signal quality assessment method includes: acquiring a heart sound signal, extracting a feature from the heart sound signal to obtain a signal feature, inputting the signal feature into a pre-trained signal quality assessment model, and outputting a signal quality assessment result. The signal feature includes one or more of a local variance feature, a local peak feature, a signal energy feature, and a zero-crossing rate feature.

### CROSS-REFERENCE TO RELATED APPLICATIONS

The present application is a continuation application of International Application No. PCT/CN2024/132579, filed on Nov. 18, 2024, which claims priority to Chinese Patent Application No. 202410451061.3, filed on Apr. 15, 2024. The disclosures of the above-mentioned applications are incorporated herein by reference in their entireties.

### TECHNICAL FIELD

The present application relates to the technical field of signal processing, and in particular to a heart sound signal quality assessment method, an electronic device, and a readable storage medium.

### BACKGROUND

Heart sounds are the sounds produced by the vibrations caused by the contraction of the myocardium, the closing of the heart valves, and the impact of blood on the walls of the ventricles and aorta. These sounds can be heard using a stethoscope at a specific location on the chest wall. These sounds can now also be heard using electronic stethoscopes, which convert heart sounds into digital audio signals for storage.

Due to the complexity of clinical environments, the process of acquiring heart sound signals inevitably introduces interference and noise caused by human factors or environmental factors. Existing methods often use denoising techniques such as filtering to reduce the impact of interference and noise. However, since noise interference can be mixed with heart sounds in the time domain, frequency domain, or other transform domains, denoising methods are not effective in removing certain noise interferences. To ensure the accuracy of results based on heart sound signal analysis, signal quality must be evaluated.

However, there is currently a lack of an effective quality assessment method for heart sound signals to evaluate the quality of heart sound signals (for example, signal quality index, SQI).

The disclosure of the above background technology content is only used to assist in understanding the inventive concept and technical solution of the present application. It does not necessarily belong to the related art of the present application, nor does it necessarily provide technical guidance. It is to provide general background information and does not necessarily constitute related art.

### SUMMARY

The main purpose of the present application is to provide a heart sound signal quality assessment method, device, an electronic device and a readable storage medium, aiming to solve the technical problem of how to effectively assess the signal quality of heart sound signals.

To achieve the above objectives, the present application provides a heart sound signal quality assessment method, which includes:
acquiring a heart sound signal;
extracting a feature from the heart sound signal to obtain a signal feature, wherein the signal feature includes one or more of a local variance feature, a local peak feature, a signal energy feature, and a zero-crossing rate feature; and
inputting the signal feature into a pre-trained signal quality assessment model, and outputting a signal quality assessment result.

In an embodiment, the extracting feature from the heart sound signal to obtain the signal feature includes:
performing sliding window processing on the heart sound signal, and taking the heart sound signal within the sliding window as a sub-heart sound signal; and
for each sub-heart sound signal, extracting a feature from the sub-heart sound signal to obtain a signal feature corresponding to the sub-heart sound signal.

In an embodiment, in response to that the signal feature includes the local variance feature, the extracting the feature from the sub-heart sound signal to obtain the signal feature corresponding to the sub-heart sound signal includes:
performing sliding window processing on the sub-heart sound signal, and taking the sub-heart sound signal within the sliding window as a secondary sub-heart sound signal;
determining a signal value standard deviation of each secondary sub-heart sound signal, and taking a variance of all the signal value standard deviations as a first variance feature;
taking a mean of all the signal value standard deviations as a first mean, and sorting all the signal value standard deviations to obtain a standard deviation sequence, wherein the standard deviation sequence includes the signal value standard deviations sorted in descending order based on numerical values;
determining a first preset number of signal value standard deviations in the standard deviation sequence;
taking a mean of the first preset number of signal value standard deviations as a second mean, and taking a ratio of the first mean to the second mean as a second variance feature;
taking a variance of starting sampling point positions of all the windows as a third variance feature; and
taking one or more of the first variance feature, the second variance feature, and the third variance feature as the local variance feature.

In an embodiment, in response to that the signal feature includes the local peak feature, the extracting the feature from the sub-heart sound signal to obtain the signal feature corresponding to the sub-heart sound signal includes:
determining a signal peak value of the sub-heart sound signal, and adjusting the signal peak value based on a first preset adjustment coefficient to obtain a first threshold, wherein the first threshold is smaller than the signal peak value;
determining a first target signal value greater than the first threshold among signal values of the sub-heart sound signal, and taking a sampling point number of signal sampling points corresponding to the first target signal value as a first sampling point number;
adjusting the signal peak value based on a second preset adjustment coefficient to obtain a second threshold, wherein the second threshold is smaller than the signal peak value, and the second preset adjustment coefficient is smaller than the first preset adjustment coefficient;
determining a second target signal value smaller than the second threshold among the signal values of the sub-heart sound signal, and taking a sampling point number of signal sampling points corresponding to the second target signal value as a second sampling point number; and
taking the first sampling point number and/or the second sampling point number as the local peak feature.

In an embodiment, in response to that the signal feature includes the signal energy feature, the extracting the feature from the sub-heart sound signal to obtain the signal feature corresponding to the sub-heart sound signal includes:
performing a Fourier transform on the sub-heart sound signal, and taking the sub-heart sound signal after the Fourier transform as a target signal;
determining a signal energy corresponding to each frequency of the target signal, and determining a total signal energy of all the signal energies;
determining a first frequency smaller than a first preset frequency among all frequencies comprised in the target signal, determining the signal energy corresponding to each first frequency, and taking the total energy of the signal energies corresponding to all the first frequencies as a low-frequency energy distribution ratio;
determining a second frequency greater than a second preset frequency among all frequencies comprised in the target signal, determining the signal energy corresponding to each second frequency, and taking the total energy of the signal energies corresponding to all the second frequencies as a high-frequency energy distribution ratio, wherein the second preset frequency is greater than or equal to the first preset frequency;
inputting the target signal into a preset logarithmic energy feature extraction model, and outputting a logarithmic energy; and
taking one or more of the total signal energy, the low-frequency energy distribution ratio, the high-frequency energy distribution ratio and the logarithmic energy as signal energy feature.

In an embodiment, in response to that the signal feature includes the zero-crossing rate feature, the extracting the feature from the sub-heart sound signal to obtain the signal feature corresponding to the sub-heart sound signal includes:
determining a zero-crossing rate of the sub-heart sound signal in each frame, wherein the zero-crossing rate includes a ratio of a zero-crossing signal sampling point number to a total signal sampling point number of the heart sound signal in one frame;
determining a maximum zero-crossing rate among all the zero-crossing rates, and determining a minimum zero-crossing rate among all the zero-crossing rates;
performing differential processing on all the zero-crossing rates to obtain first-order differential zero-crossing rates;
determining a maximum first-order differential zero-crossing rate among all the first-order differential zero-crossing rates, and determining a variance of all the first-order differential zero-crossing rates;
performing differential processing on all the first-order differential zero-crossing rates to obtain second-order differential zero-crossing rates;
determining a maximum second-order differential zero-crossing rate among all the second-order differential zero-crossing rates, and determining a standard deviation of all the second-order differential zero-crossing rates; and
taking one or more of the maximum zero-crossing rate, the minimum zero-crossing rate, the maximum first-order differential zero-crossing rate, the variance of all the first-order differential zero-crossing rates, the maximum second-order differential zero-crossing rate and the standard deviation of all the second-order differential zero-crossing rates as zero-crossing rate feature.

In an embodiment, the inputting the signal feature into the pre-trained signal quality assessment model, and outputting the signal quality assessment result includes:
inputting the signal feature corresponding to each the sub-heart sound signal into the pre-trained signal quality assessment model, and outputting a signal quality assessment result of each sub-heart sound signal.

In an embodiment, before the extracting the feature from the heart sound signal to obtain the signal feature, the method further includes:
performing signal filtering processing on the heart sound signal to obtain a filtered heart sound signal, wherein the signal filtering includes a zero-phase-shift Butterworth filter;
performing signal clipping processing on the filtered heart sound signal to obtain a preprocessed heart sound signal, wherein the signal clipping includes clipping a head end of heart sound signal with a preset time length and/or a tail end of heart sound signal with a preset time length; and
extracting the feature from the heart sound signal to obtain the signal feature based on the preprocessed heart sound signal.

In addition, to achieve the above-mentioned purpose, the present application further provides a heart sound signal quality assessment device, including:
a signal acquisition module, configured to acquire a heart sound signal;
a feature extraction module, configured to extract feature from the heart sound signal to obtain signal feature, wherein the signal features include one or more of a local variance feature, a local peak feature, a signal energy feature, and a zero-crossing rate feature; and
a quality assessment module, configured to input the signal feature into a pre-trained signal quality assessment model and output a signal quality assessment result.

The present application also provides an electronic device, which is a physical device, and includes at least one processor and a memory communicatively connected to the at least one processor. The memory stores instructions executable by the at least one processor, and the instructions are executed by the at least one processor to enable the at least one processor to perform the steps of the heart sound signal quality assessment method as described above.

The present application also provides a non-transitory computer-readable storage medium. The non-transitory computer-readable storage medium stores a program for implementing the heart sound signal quality assessment method. The program for implementing the heart sound signal quality assessment method is executed by a processor to implement the steps of the heart sound signal quality assessment method as described above.

The present application also provides a computer program product, including a computer program, which implements the steps of the heart sound signal quality assessment method as described above when executed by a processor.

In the present application, a heart sound signal is acquired, feature extraction is performed on the heart sound signal to obtain the signal feature, which includes one or more of local variance feature, local peak feature, signal energy feature, and zero-crossing rate feature. The signal feature is input into a pre-trained signal quality assessment model, and a signal quality assessment result is output. Thus, the embodiment of the present application extracts signal features such as local variance features, local peak features, signal energy features, and zero-crossing rate features of the heart sound signal, and evaluates the signal quality of the heart sound signal in multiple dimensions based on the signal features of the heart sound signal, thereby achieving effective signal quality assessment of the heart sound signal.

### BRIEF DESCRIPTION OF THE DRAWINGS

The accompanying drawings, which are incorporated in and constitute a part of this specification, illustrate embodiments consistent with the present application and, together with the specification, serve to explain the principles of the present application.

In order to more clearly illustrate the embodiments of the present application or the technical solutions in the related art, the following briefly introduces the drawings required for use in the description of the embodiments or the related art. Obviously, for those skilled in the art, other drawings can be obtained based on these drawings without any creative efforts.

FIG. 1 is a flow chart of a heart sound signal quality assessment method according to an embodiment of the present application.

FIG. 2 is a flow chart of a heart sound signal quality assessment method according to an embodiment of the present application.

FIG. 3 is a flow chart of a heart sound signal quality assessment method according to an embodiment of the present application.

FIG. 4 is a flow chart of a heart sound signal quality assessment method according to an embodiment of the present application.

FIG. 5 is a flow chart of a heart sound signal quality assessment method according to an embodiment of the present application.

FIG. 6 is a flow chart of a heart sound signal quality assessment method according to an embodiment of the present application.

FIG. 7 is a flow chart of a heart sound signal quality assessment method according to an embodiment of the present application.

FIG. 8 is a flow chart of a heart sound signal quality assessment method according to an embodiment of the present application.

FIG. 9 is a flow chart of a heart sound signal quality assessment method according to an embodiment of the present application.

FIG. 10 is a flowchart of a specific application scenario of a heart sound signal quality assessment method of the present application.

FIG. 11 is another flowchart of a specific application scenario of a heart sound signal quality assessment method of the present application.

FIG. 12 is a device module schematic diagram of the heart sound signal quality assessment device of the present application.

FIG. 13 is a device structure schematic diagram of the hardware operating environment involved in a heart sound signal quality assessment device according to an embodiment of the present application.

The purpose, features and advantages of the present application will be further explained in conjunction with the embodiments and with reference to the accompanying drawings.

### DETAILED DESCRIPTION OF THE EMBODIMENTS

To make the above-mentioned objects, features, and advantages of the present application more clearly understood, the technical solutions in the embodiments of the present application will be clearly and completely described below in conjunction with the accompanying drawings of the embodiments of the present application. Obviously, the described embodiments are only some of the embodiments of the present application, not all of them. Based on the embodiments of the present application, all other embodiments obtained by those skilled in the art without making any creative efforts shall fall within the scope of the present application.

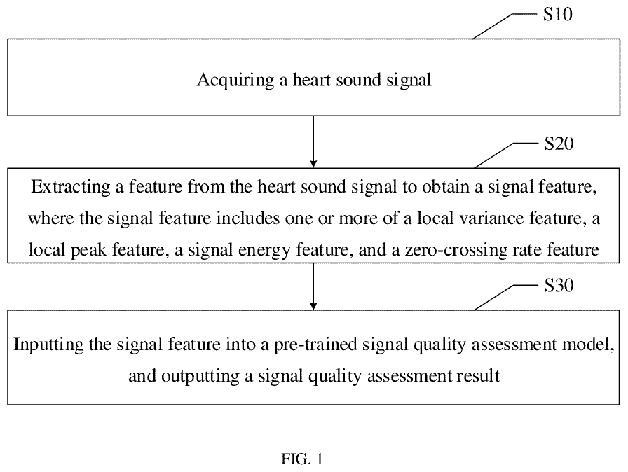

The present application proposes an embodiment of a heart sound signal quality assessment method. As shown in FIG. 1, the heart sound signal quality assessment method includes:
Step S10, acquiring a heart sound signal.

As a feasible implementation, heart sound signals can be acquired using sensors, such as one or more of a voice pick up (VPU) bone conduction sensor and a microphone sensor, though this embodiment does not impose any specific limitations on this. Furthermore, heart sound signals can be acquired at a preset signal sampling rate. This preset signal sampling rate can be any pre-set sampling rate, such as 1000 Hz, and this embodiment does not impose any specific limitations on this.

Furthermore, before extracting the signal features, in order to improve the accuracy of the extracted signal features, the heart sound signal may be preprocessed, such as filtering, noise reduction, normalization, etc. The signal features are extracted based on the preprocessed heart sound signal.

In addition, the user's acceleration signal can also be acquired through a 6-axis signal acquisition module. Acceleration signals and gyroscope signals are primarily acquired through this 6-axis signal acquisition module, which primarily consists of a 6-axis sensor integrated within the device. Before signal acquisition, the 6-axis signal acquisition module calculates the current Euler angles to assist the user in determining the acquisition position and posture. During signal acquisition, the 6-axis signal acquisition module monitors the user's arm movement and combines it with the heart sound signal to perform signal denoising, thereby improving the signal-to-noise ratio during the acquisition process.
Step S20, extracting a feature from the heart sound signal to obtain a signal feature. The signal feature includes one or more of a local variance feature, a local peak feature, a signal energy feature, and a zero-crossing rate feature.

The signal features include, but are not limited to, local variance features, local peak features, signal energy features, and zero-crossing rate features, and may also include kurtosis and skewness. In this embodiment, the signal features include local variance features, local peak features, signal energy features, and zero-crossing rate features, thereby evaluating the signal quality of the heart sound signal from multiple perspectives and improving the accuracy of the heart sound signal quality assessment.

$$ssqi = \frac{N ( N + 1 )}{( N - 1 ) ( N - 2 ) ( N - 3 )} {\sum }_{i = 1}^{N} {( \frac{{X}_{i} - μ}{σ} )}^{4} - \frac{3 {( N - 1 )}^{2}}{( N - 2 ) ( N - 3 )}$$

$$ksqi = \frac{N}{( N - 1 ) ( N - 2 )} {\sum }_{i = 1}^{N} {( \frac{{X}_{i} - μ}{0} )}^{3}$$

Where ssqi represents skewness, ksqi represents kurtosis, N represents the length of the signal, Xi represents the signal value of the i-th signal sampling point, μ represents the mean of the signal value, and σ represents the standard deviation of the signal value. It should be noted that the length of the signal can be the time length of the signal or the sampling point number, that is, N can be the number of all sampling points included in the signal, or it can be the total time length of the signal. In this embodiment, the sampling point number included in the signal is used as the length of the signal.

In an implementation, as shown in FIG. 2, the step of the extracting feature from the heart sound signal to obtain the signal feature includes:
Step S201, performing sliding window processing on the heart sound signal, and taking the heart sound signal within the sliding window as a sub-heart sound signal.

Sliding window processing can be performed on the heart sound signal using a preset window length and a preset step size. The preset window length and step size can be set separately in advance, such as a window length of five seconds and a step size of two seconds. This embodiment does not impose specific limitations on this. It should be noted that in this embodiment, the window length is greater than the step size to allow overlap between adjacent windows, thereby improving the accuracy of signal quality assessment and reducing discarded signals (illustratively, in this embodiment, signals with poor signal quality assessment results are discarded). For example, assuming the sliding window step size is q and the window length is q*3, the heart sound signal is divided into [q1, q2, q3, q4] by the length of q. [q1, q2, q3] represents a sub-heart sound signal with a poor signal quality assessment result, and [q2, q3, q4] represents a sub-heart sound signal with a medium signal quality assessment result. In this case, only q1 is discarded, rather than discarding q1, q2, and q3, thereby reducing discarded signals.
Step S202, for each sub-heart sound signal, extracting a feature from the sub-heart sound signal to obtain a signal feature corresponding to the sub-heart sound signal.

Feature extraction is performed on each sub-heart sound signal, so that the signal quality of each sub-heart sound signal can be evaluated based on the signal features corresponding to each sub-heart sound signal.
Step S30, inputting the signal feature into a pre-trained signal quality assessment model, and outputting a signal quality assessment result.

The signal quality assessment model is pre-trained using a training dataset. Specifically, it can use a machine learning algorithm to implement nonlinear, efficient, and lightweight heart sound signal quality assessment. The signal quality assessment results can include quality levels, such as good, medium, and poor.

As one of the implementations, the signal features of the entire heart sound signal (such as the complete acquired heart sound signal) can be extracted, and the extracted signal features can be input into a pre-trained signal quality assessment model to output the quality assessment result of the entire heart sound signal.

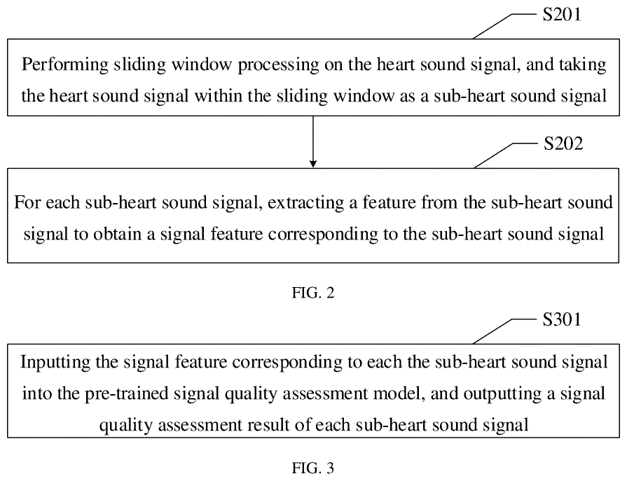

As another implementation, as shown in FIG. 3, the step of inputting the signal feature into a pre-trained signal quality assessment model, and outputting a signal quality assessment result includes:
Step S301, inputting the signal feature corresponding to each the sub-heart sound signal into the pre-trained signal quality assessment model, and outputting a signal quality assessment result of each sub-heart sound signal.

Based on the signal features corresponding to each sub-heart sound signal, the signal quality of the sub-heart sound signal is evaluated, so that the signal quality distribution of different parts in the entire signal can be obtained, thereby improving the precision of the heart sound signal quality evaluation.

In this embodiment, a heart sound signal is acquired. Feature extraction is performed on the heart sound signal to obtain signal features, and the signal features include one or more of local variance features, local peak features, signal energy features, and zero-crossing rate features. The signal features are input into a pre-trained signal quality assessment model, and a signal quality assessment result is output. Thus, this embodiment extracts signal features such as local variance features, local peak features, signal energy features, and zero-crossing rate features of the heart sound signal, and evaluates the signal quality of the heart sound signal in multiple dimensions based on the signal features of the heart sound signal, thereby achieving effective signal quality assessment of the heart sound signal.

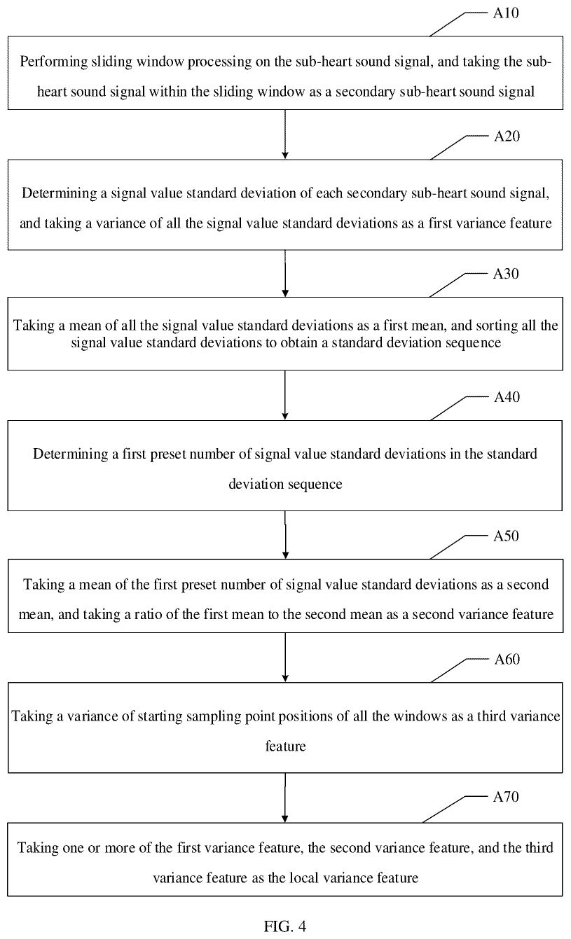

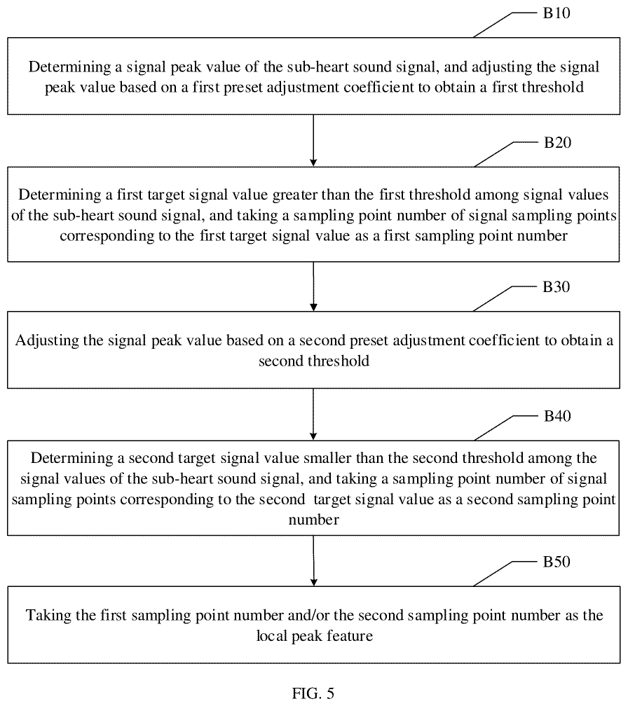

In this embodiment of the present application, the same or similar contents as those in the above-mentioned embodiments can be referred to the above introduction and will not be repeated hereafter. On this basis, as shown in FIG. 4, when the signal feature includes a local variance feature, the step of extracting the feature from the sub-heart sound signal to obtain the signal feature corresponding to the sub-heart sound signal includes:
Step A10, performing sliding window processing on the sub-heart sound signal, and taking the sub-heart sound signal within the sliding window as a secondary sub-heart sound signal.

The sub-heart sound signal can be subjected to sliding window processing using a preset window length and a preset step size. The preset window length and the preset step size can be set in advance, such as 200 signal sampling points as the length and 50 signal sampling points as the step size for sliding window processing. This embodiment does not impose any specific restrictions on this.
Step A20, determining a signal value standard deviation of each secondary sub-heart sound signal, and taking a variance of all the signal value standard deviations as a first variance feature.

$${σ}_{s t d , i} = \sqrt{\frac{1}{K - 1} {\sum }_{k = 1}^{K} {( s t d ( {S}_{i , qk : qk + m} ) - {μ}_{s t d , i} )}^{2}}$$

Where σ_{std,i} represents the first variance feature of the i-th segment sub-heart sound signal, q represents the sliding step size of the sliding window processing of the sub-heart sound signal, m represents the sliding window length of the sliding window processing of the sub-heart sound signal.

$$K = ⌊ \frac{M - m}{q} ⌋$$

$${μ}_{s t d , i} = \frac{1}{K} {\sum }_{k = 1}^{K} s t d ( {S}_{i , qk : q k + m} )$$

std represents the signal value standard deviation, S_{i,j} represents the signal value of the j-th signal sampling point of the i-th segment sub-heart sound signal, S_{i,gk:qk+m} represents the signal value corresponding to each signal sampling point between the qk-th signal sampling point and the qk+m-th signal sampling point of the i-th segment sub-heart sound signal, and M represents the signal length of the i-th segment sub-heart sound signal. In this embodiment, M is the total number of signal sampling points included in the i-th segment sub-heart sound signal.
Step A30, taking a mean of all the signal value standard deviations as a first mean, and sorting all the signal value standard deviations to obtain a standard deviation sequence. The standard deviation sequence includes the signal value standard deviations sorted in descending order based on numerical values.
Step A40, determining a first preset number of signal value standard deviations in the standard deviation sequence.
Step A50: taking a mean of the first preset number of signal value standard deviations as a second mean, and taking a ratio of the first mean to the second mean as a second variance feature.

$${max}_{Npea {k}_{i}} = \frac{\frac{1}{N} {\sum }_{n = 1}^{N} s t d ( {S}_{i , {p}_{n , i} : {p}_{n , i} + m} )}{{μ}_{s td , i}}$$

Where max_{Npeak}_{ᵢ} represents the second variance feature of the i-th segment sub-heart sound signal, N is a preset number, p_{n,i} represents the starting sampling point position of the window corresponding to the n-th largest signal value standard deviation (ordered from largest to smallest, the n-th value) in the i-th segment sub-heart sound signal. This is also the starting sampling point position of the window of the sliding window corresponding to the n-th largest signal value standard deviation in the i-th segment sub-heart sound signal. It should be noted that the second variance feature can be one or more, with each different value of N corresponding to a second variance feature. N can be any pre-set value, such as 24, 12, 6, etc., and this embodiment does not impose any specific limitation on this.

In an implementation, the signal sampling point position can specifically be the number of the signal sampling point. For example, by sequentially numbering the signal sampling points of the sub-heart sound signal starting from 1, a sampling point number corresponding to each signal sampling point can be obtained, and the sampling point number can be used as the signal sampling point position of the signal sampling point. In another implementation, the time corresponding to each signal sampling point can be used as the signal sampling point position. In this embodiment, the sampling point number is used as the signal sampling point position of the signal sampling point.
Step A60, taking a variance of starting sampling point positions of all the windows as a third variance feature.

$${max}_{{N}_{{peak \_ diffstd}_{i}}} = \sqrt{\frac{1}{N - 1} {\sum }_{n = 1}^{N} {( {p}_{n , i} - {μ}_{p , i} )}^{2}}$$

Where max N_{peak_diffstd}_{ᵢ} represents the third variance feature of the i-th segment heart sound signal,

$${μ}_{p , i} = \frac{1}{N} \sum {}_{n = 1}^{N} {p}_{n , i} .$$

It should be noted that the third variance feature can be one or more, and each different value of N corresponds to a third variance feature. N can be any value set in advance, such as 24, 12, 6, etc. This embodiment does not impose any specific restrictions on this.
Step A70, taking one or more of the first variance feature, the second variance feature, and the third variance feature as the local variance feature.

In this embodiment, the first variance feature, the second variance feature, and the third variance feature are used as local variance features.

In this embodiment, a sliding window with a suitable time window length and step size is further designed for the acquired heart sound signal, and the variance change features of the sliding window are calculated. This can effectively extract the peak values generated by the heart vibration within the sampling time and the peak values caused by external noise. Extracting the distribution features of these peak values (the first variance features, the second variance features, and the third variance features in this embodiment, etc.) can effectively reflect the strength of the noise in this section of the heart sound signal, with good sensitivity and robustness.

In an implementation, as shown in FIG. 5, when the signal feature includes a local peak feature, the step of extracting the feature from the sub-heart sound signal to obtain the signal feature corresponding to the sub-heart sound signal includes:
Step B10, determining a signal peak value of the sub-heart sound signal, and adjusting the signal peak value based on a first preset adjustment coefficient to obtain a first threshold. The first threshold is smaller than the signal peak value.
Step B20, determining a first target signal value greater than the first threshold among signal values of the sub-heart sound signal, and taking a sampling point number of signal sampling points corresponding to the first target signal value as a first sampling point number.

$${C}_{h 1 , i} = {\sum }_{j = 1}^{M} ( {S}_{i , j} > h 1 \times max ( {S}_{i} ) )$$

Where C_{h1,i} represents the first sampling point number of the i-th segment sub-heart sound signal, h1 represents the first preset adjustment coefficient, max(Si) represents the calculation of the peak value of the i-th segment sub-heart sound signal, that is, the maximum signal value, and [symbol] (condition) is an indicator function, which is 1 when (condition) is true, otherwise it is 0.

It should be noted that the first sampling point number can be one or more, and each different value of h1 corresponds to a first sampling point number. h1 can be any value set in advance, such as 0.8, 0.6, etc., and this embodiment does not impose any specific limitation on this.
Step B30, adjusting the signal peak value based on a second preset adjustment coefficient to obtain a second threshold. The second threshold is smaller than the signal peak value, and the second preset adjustment coefficient is smaller than the first preset adjustment coefficient.
Step B40, determining a second target signal value smaller than the second threshold among the signal values of the sub-heart sound signal, and taking a sampling point number of signal sampling points corresponding to the second target signal value as a second sampling point number.

$${C}_{h 2 , i} = {\sum }_{j = 1}^{M} ( {S}_{i , j} < h 2 \times max ( {S}_{i} ) )$$

Where C_{h2,i} represents the second sampling point number of the i-th segment sub-heart sound signal, and h2 is the second preset adjustment coefficient.

It should be noted that the second sampling point number can be one or more, and each different value of h2 corresponds to a second sampling point number. h2 can be any value set in advance, such as 0.4, 0.1, etc., and this embodiment does not impose any specific limitation on this.
Step B50, taking the first sampling point number and/or the second sampling point number as the local peak feature.

In this embodiment, the first sampling point number and the second sampling point number are used as local peak features.

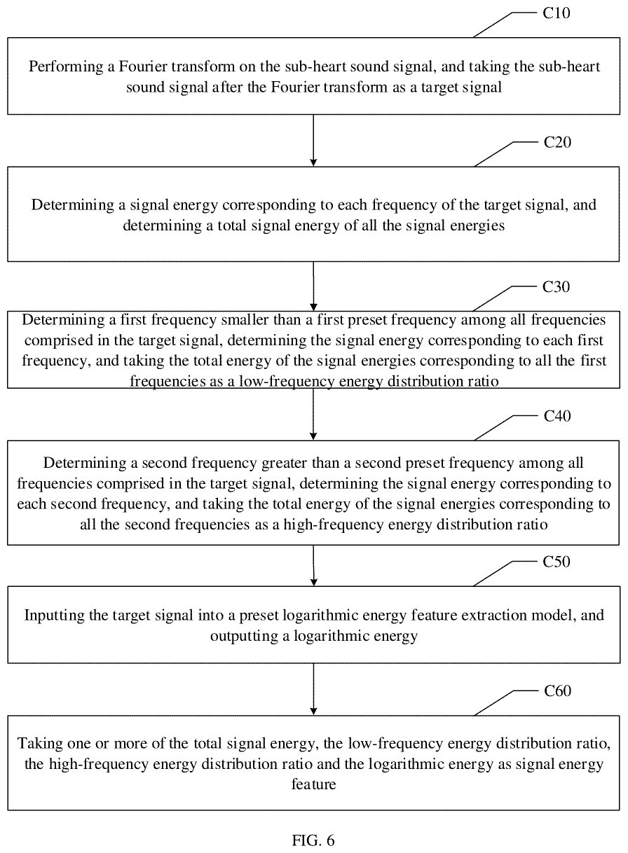

In an implementation, as shown in FIG. 6, when the signal feature includes a signal energy feature, the step of extracting the feature from the sub-heart sound signal to obtain the signal feature corresponding to the sub-heart sound signal includes:
Step C10, performing a Fourier transform on the sub-heart sound signal, and taking the sub-heart sound signal after the Fourier transform as a target signal.

Specifically, a short-time Fourier transform can be performed on the sub-heart sound signal. It can be understood that after the Fourier transform, the energy values corresponding to F different frequency points at each time t of the sub-heart sound signal are obtained. In other words, the target signal includes the energy values corresponding to F different frequency points at each time t.
Step C20, determining a signal energy corresponding to each frequency of the target signal, and determining a total signal energy of all the signal energies.

$${total\_power}_{-} i = {\sum }_{t = 0}^{T} {\sum }_{f = 1}^{F} Pxx [ f , t ]$$

Where total_power_i represents the total signal energy of the i-th segment sub-heart sound signal, T represents the total time length of the target signal, f represents the f-th frequency after transformation, and Pxx[f, t] represents the signal energy of the target signal at time t(s) and frequency f(Hz).
Step C30, determining a first frequency smaller than a first preset frequency among all frequencies comprised in the target signal, determining the signal energy corresponding to each first frequency, and taking the total energy of the signal energies corresponding to all the first frequencies as a low-frequency energy distribution ratio.

$${energy\_below}_{-} {i}_{-} f1 = {\sum }_{f < f 1} Pxx [ f ]$$

Where energy_below_i_f1 represents the low-frequency energy distribution ratio of the i-th segment sub-heart sound signal, f1 represents the first preset frequency, and Pxx[f] represents the signal energy of the target signal at the frequency f (Hz) at all times.

It should be noted that the low-frequency energy distribution ratio can be one or more, and each different value of f1 corresponds to a low-frequency energy distribution ratio. f1 can be any value set in advance, such as 100 Hz, 120 Hz, etc. This embodiment does not impose any specific restrictions on this.
Step C40, determining a second frequency greater than a second preset frequency among all frequencies comprised in the target signal, determining the signal energy corresponding to each second frequency, and taking the total energy of the signal energies corresponding to all the second frequencies as a high-frequency energy distribution ratio. The second preset frequency is greater than or equal to the first preset frequency.

$${energy\_above}_{-} i\_f2 = {\sum }_{f > f 2} Pxx [ f ]$$

Where energy_above_i_f2 represents the high-frequency energy distribution ratio of the i-th segment sub-heart sound signal, f2 represents the second preset frequency, Pxx[f] represents the signal energy of the target signal at the frequency f (Hz) at all times.

It should be noted that the high-frequency energy distribution ratio can be one or more, and each different value of f2 corresponds to a high-frequency energy distribution ratio. f2 can be any value set in advance, such as 250 Hz, 270 Hz, etc. This embodiment does not impose any specific restrictions on this.
Step C50, inputting the target signal into a preset logarithmic energy feature extraction model, and outputting a logarithmic energy.

The preset logarithmic energy feature extraction model may include one or more of the following calculation formulas:

$$log\_energy [ t ] = log ( {\sum }_{f = 1}^{F} Pxx [ f , t ] + 1 \times 1 {0}^{- 10} )$$

$$log\_energy \_diff [ t ] = {log}_{-} energy [ t ] - log\_energy [ t - 1 ]$$

$$log\_energy \_std = std ( log\_energy )$$

$$log\_energy \_diff \_mean = \frac{1}{T} {\sum }_{t = 1}^{T} log\_energy \_diff [ t ]$$

$$log\_energy {\_diff}_{-} max = max ( log\_energy \_diff )$$

$$log\_energy \_diff \_std = std ( log\_energy \_diff )$$

Where std represents the standard deviation.

Therefore, the logarithmic energy includes one or more logarithmic energies of log_energy[t], log_energy_diff[t], log_energy_std, log_energy_diff_mean, log_energy_diff_max and log_energy_diff_std. In this embodiment, the logarithmic energy includes log_energy[t], log_energy_diff[t], log_energy_std, log_energy_diff_mean, log_energy_diff_max and log_energy_diff_std.

In step C60, taking one or more of the total signal energy, the low-frequency energy distribution ratio, the high-frequency energy distribution ratio and the logarithmic energy as signal energy feature.

In this embodiment, the total signal energy, the low-frequency energy distribution ratio, the high-frequency energy distribution ratio and the logarithmic energy are used as signal energy features.

Considering that heart sound signals are essentially vibration signals generated by cardiac vibrations, their signal features are very similar to those of sound signals. In this embodiment, features commonly used in sound signal processing, such as spectrum maps, zero-crossing rates, and logarithmic energy spectra, can be used to effectively determine whether the desired sound signal exists at a given moment. In heart sound signal processing, these features can effectively determine the occurrence time and intensity of cardiac systole and diastole, as well as the occurrence time and intensity of other noise. Based on the temporal distribution of these features, it is possible to effectively determine whether the processed heart sound signal conforms to physiological cardiac vibrations, and thus determine whether the processed signal quality meets the requirements, thereby improving the accuracy of heart sound signal quality assessment.

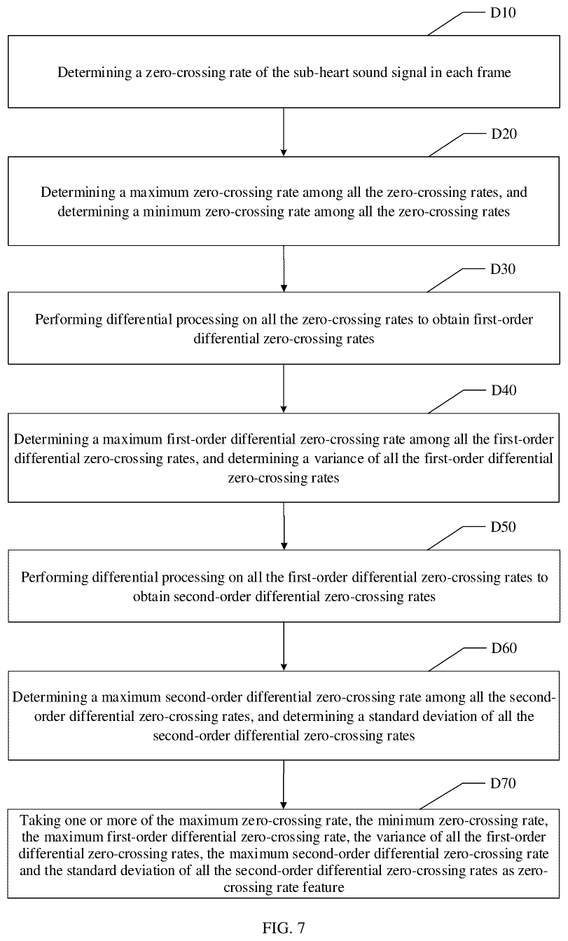

In an implementation, as shown in FIG. 7, when the signal feature includes a zero-crossing rate feature, the step of extracting the feature from the sub-heart sound signal to obtain the signal feature corresponding to the sub-heart sound signal includes:
Step D10, determining a zero-crossing rate of the sub-heart sound signal in each frame. The zero-crossing rate includes a ratio of a zero-crossing signal sampling point number to a total signal sampling point number of the heart sound signal in one frame.

Specifically, a preset number of signal sampling points can be used as a frame, such as 50 signal sampling points.

$${Z}_{i} [ k ] = \frac{1}{q - 1} {\sum }_{j = q ( k - 1 ) + 1}^{q k - 1} ( sign ( {S}_{i , j} ) \neq sign ( {S}_{i , j + 1} ) ) , k = 1 , 2 , … , ⌊ \frac{M}{50} ⌋$$

Where Zᵢ[k] represents the zero-crossing rate of the k-th frame of the i-th segment sub-heart sound signal, q represents the signal sampling point number in a frame, sign and is a sign function that returns 1 for positive numbers, −1 for negative numbers, and 0 for zero.
Step D20, determining a maximum zero-crossing rate among all the zero-crossing rates, and determining a minimum zero-crossing rate among all the zero-crossing rates.

$$zero\_crossing \_rate \_i \_max = max ( {Z}_{i} )$$

Where zero_crossing_rate_i_max represents the maximum zero-crossing rate of the i-th segment sub-heart sound signal, and Zᵢ represents the zero-crossing rate of each frame signal of the i-th segment sub-heart sound signal.

$$zero\_crossing \_rate \_i \_min = min ( {Z}_{i} )$$

Where zero_crossing_rate_i_min represents the minimum zero-crossing rate of the i-th segment sub-heart sound signal, and Zᵢ represents the zero-crossing rate of each frame signal of the i-th segment sub-heart sound signal.
Step D30, performing differential processing on all the zero-crossing rates to obtain first-order differential zero-crossing rates.
Step D40, determining a maximum first-order differential zero-crossing rate among all the first-order differential zero-crossing rates, and determining a variance of all the first-order differential zero-crossing rates.

$$zero\_crossing \_rate \_i {\_diff}_{-} max = max ( diff ( {Z}_{i} ) )$$

Where zero_crossing_rate_i_diff_max represents the maximum first-order differential zero-crossing rate of the i-th segment heart sound signal, and diff represents differential calculation.

$$zero\_crossing \_rate \_i {\_diff}_{-} var = var ( diff ( {Z}_{i} ) )$$

Where zero_crossing_rate_i_diff_var represents the variance of the first-order differential zero-crossing rate of the i-th segment heart sound signal, and var represents variance calculation.
Step D50, performing differential processing on all the first-order differential zero-crossing rates to obtain second-order differential zero-crossing rates.
Step D60, determining a maximum second-order differential zero-crossing rate among all the second-order differential zero-crossing rates, and determining a standard deviation of all the second-order differential zero-crossing rates.

$$zero\_crossing {\_rate}_{-} {i}_{-} diff2\_max = max ( diff ( diff ( {Z}_{i} ) ) )$$

Where zero_crossing_rate_i_diff2_max represents the maximum second-order differential zero-crossing rate of the i-th segment heart sound signal.

$$zero\_crossing {\_rate}_{-} {i}_{-} diff2\_std = std ( diff ( diff ( {Z}_{i} ) ) )$$

Where zero_crossing_rate_i_diff2_std represents the standard deviation of the second-order differential zero-crossing rate of the i-th segment heart sound signal, and std represents standard deviation calculation.
Step D70, taking one or more of the maximum zero-crossing rate, the minimum zero-crossing rate, the maximum first-order differential zero-crossing rate, the variance of all the first-order differential zero-crossing rates, the maximum second-order differential zero-crossing rate and the standard deviation of all the second-order differential zero-crossing rates as zero-crossing rate feature.

In this embodiment, the maximum zero-crossing rate, the minimum zero-crossing rate, the maximum first-order differential zero-crossing rate, the variance of the first-order differential zero-crossing rate, the maximum second-order differential zero-crossing rate, and the standard deviation of the second-order differential zero-crossing rate are used as zero-crossing rate features.

The signal feature extraction method of the embodiment of the present application is not based on the cardiac cycle and does not require the location identification of the first and second heart sounds. The position identification algorithms of the first and second heart sounds are often more complex and have larger errors. The features involved in the embodiment of the present application can all be implemented with minimal computational complexity while ensuring sensitivity and specificity in heart sound signal quality assessment. This facilitates deployment on wearable devices with less computational power, allowing for real-time signal quality analysis. This allows the heart sound signal quality assessment method of the embodiment of the present application to be applied to a wider range of electronic devices, improving the universality of heart sound signal quality assessment.

In another embodiment of the present application, the same or similar contents as those above embodiments can be referred to above and will not be described in detail. On this basis, as shown in FIG. 8, before the step of extracting the feature from the heart sound signal to obtain the signal feature, the method further includes:
Step E10, performing signal preprocessing on the heart sound signal to obtain a preprocessed heart sound signal.
Step E20, extracting the feature from the heart sound signal to obtain the signal feature based on the preprocessed heart sound signal.

Preprocessing method for signal processing, such as normalization, filtering, and noise reduction, can be configured in advance. In an embodiment, the acquired signal is normalized and then filtered using a pre-designed filter. The heart sound signal is filtered, and the filtered data and acceleration signal are then processed again by adaptive filtering to remove the noise caused by motion artifacts and obtain a clean, high-quality heart sound signal.

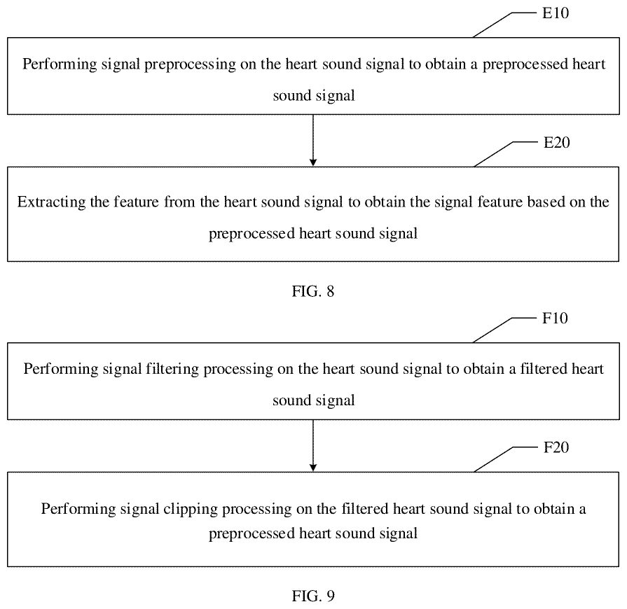

In an implementation, as shown in FIG. 9, the step of performing signal preprocessing on the heart sound signal to obtain a preprocessed heart sound signal includes:
Step F10, performing signal filtering processing on the heart sound signal to obtain a filtered heart sound signal. The signal filtering includes a zero-phase-shift Butterworth filter.

In this embodiment, the heart sound signal is filtered by a Butterworth filter in a zero-phase-shift manner to avoid phase shift after signal filtering, which may affect subsequent feature extraction.

When acquiring signals, various noises are inevitable, including motion artifacts and power frequency interference. A large part of known noise such as power frequency interference can be filtered out through filtering, thereby improving the signal-to-noise ratio of the acquired signals. This ensures that high-quality signals are utilized to the greatest extent possible for subsequent analysis. If signal quality is evaluated directly without filtering, it is likely that some noise that appears to have a large amplitude but can actually be filtered will lead to evaluation deviation. This embodiment can filter out the noise by filtering the heart sound signal, thus avoiding classifying the signal as poor-quality due to the presence of noise, which affects subsequent analysis.
Step F20, performing signal clipping processing on the filtered heart sound signal to obtain a preprocessed heart sound signal. The signal clipping includes clipping a head end of heart sound signal with a preset time length and/or clipping a tail end of heart sound signal with a preset time length.

In this embodiment, the head end of heart sound signal with the preset time length and the tail end of heart sound signal with the preset time length are cropped, and the data head and tail are cropped respectively to remove the influence of the lead establishment time and the signal distortion caused by the bandpass filtering, and obtain a usable heart sound signal to facilitate subsequent data processing.

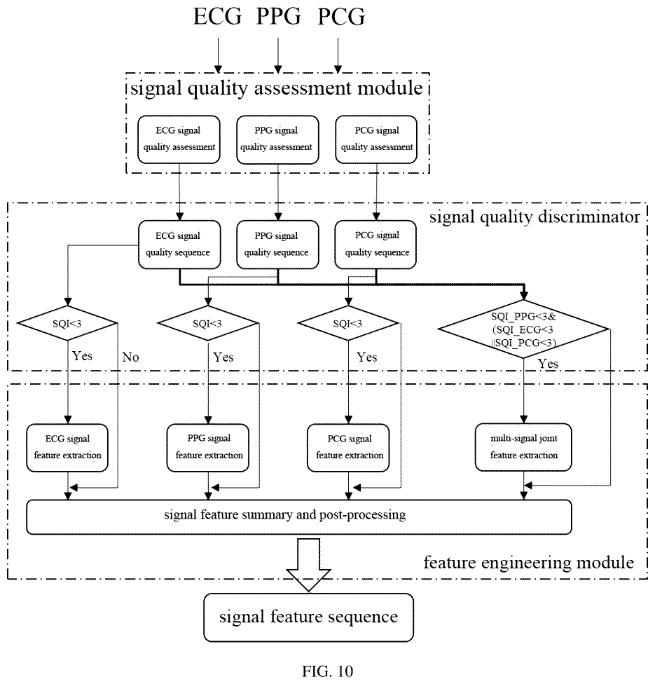

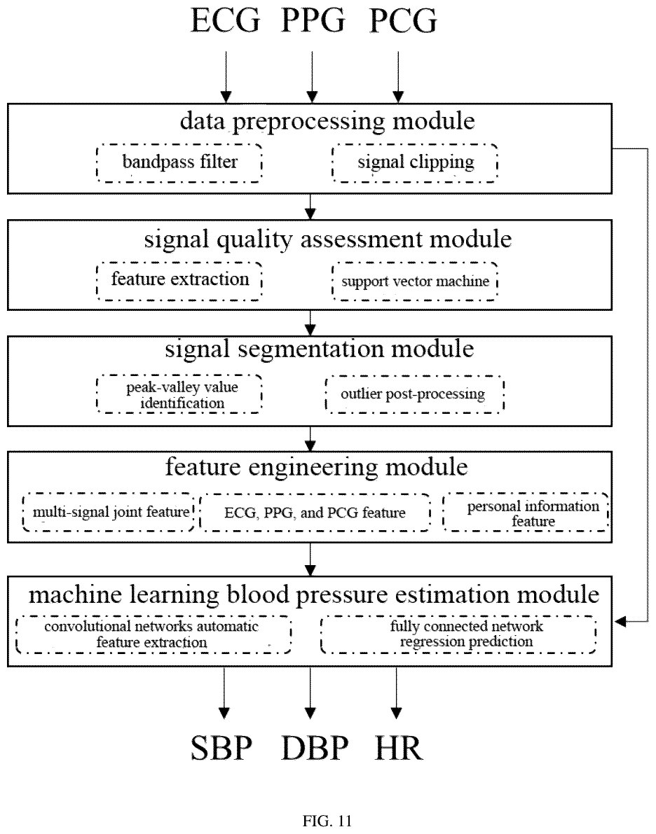

For example, in a specific application scenario, when the quality level is good, the signal quality assessment model outputs a value of 1. When the quality level is medium, the signal quality assessment model outputs a value of 2. When the quality level is poor, the signal quality assessment model outputs a value of 2. As shown in FIG. 10 and FIG. 11, in this specific application scenario:

Three synchronous physiological signals: electrocardiogram (ECG), photoplethysmography (PPG), and phonocardiogram (PCG) are acquired. The data is first processed through the data preprocessing module. The signal quality assessment module then classifies the signals into three levels: good, medium, and poor. Signals with good quality are then processed through the signal segmentation module and feature engineering module. Finally, the extracted features are put into the machine learning blood pressure estimation and analysis module to obtain systolic blood pressure (SBP), diastolic blood pressure (DBP), and heart rate (HR).

Data preprocessing module, signal quality assessment module, signal segmentation module, feature engineering module and blood pressure estimation module are provided.

The data preprocessing module consists of two parts: data filtering and data cropping. Data filtering applies Butterworth filters with different passbands to the ECG, PPG, and PCG signals, respectively, and employs a zero-phase-shift implementation to prevent phase shifts after filtering the three signals, which could affect subsequent feature extraction. Data cropping simultaneously trims the lengths of the three signals, trimming the beginning and end of the data separately to remove the effects of lead establishment time and signal distortion caused by bandpass filtering. This results in usable, equal-length, and synchronized three-channel physiological signal, facilitating subsequent data processing.

The signal quality assessment module includes ECG signal quality assessment module, PPG signal quality assessment module, and PCG signal quality assessment module. The signal quality assessment module uses a sliding window with a length of five seconds and a step size of two seconds to calculate the extracted feature values of the signals within the sliding window and use the pre-trained machine learning integration model for classification prediction. This model can be used to determine the signal quality distribution of different parts of the entire signal.

For the ECG signal quality assessment module, multiple signal features suitable for ECG signal quality assessment are extracted, including kurtosis (ksqi), skewness (ssqi), etc.

For the PPG signal quality assessment module, multiple signal features suitable for PPG signal quality assessment are used, including the zero-crossing count (zero_cross), the local count of minima below zero (Lᵢ), the average distance between adjacent minima (D̅ᵢ̅), the standard deviation of the distance between adjacent minima (σ_{D}_{ᵢ}), the smallest minima ratio (Rᵢ), the average position of the minima, the average peak-to-valley amplitude, the standard deviation of the peak-to-valley amplitude, the peak-to-valley maximum amplitude ratio, the average peak-to-valley time difference, the standard deviation of the peak-to-valley time difference, the valley amplitude variation coefficient, etc.

For the PCG quality assessment module, by referring to multiple features commonly used in speech signal processing and combining them with heart sound signal features, multiple signal features suitable for PCG signal quality assessment are innovatively proposed, including time domain features and frequency domain features. Time domain features include the mean, variance, local variance features, and local peak features of the signal. Frequency domain features include total energy, energy distribution ratio, zero-crossing rate features, first-order and second-order differences of zero-crossing rate, logarithmic energy features, and first-order and second-order differences of logarithmic energy.

The signal segmentation module segments high-quality segments to separate different heartbeats. Signal segmentation is a two-step process. First, the QRS complexes or pulse valleys of the ECG signal are identified to initially segment the signal into different heartbeats. Subsequently, the segmented heartbeats are post-processed by setting upper and lower thresholds for beat length and removing outliers (e.g., removing heartbeat signals whose beat length is greater than the upper threshold or whose beat length is less than the lower threshold), resulting in highly accurate signal segmentation results.

The feature engineering module includes ECG signal features, PPG signal features, PCG signal features, multi-signal joint time difference features, and personal information features. ECG signal features include heart rate variability (HRV) time domain features, HRV frequency domain features, and nonlinear features. PPG signal features include pulse amplitude features, heart rate features, pulse morphology features, and pulse variability features. PCG signal features include the duration of the first heart sound, systolic duration, diastolic duration, energy features, and main frequency component features. Multi-signal joint difference time features include the ECG R-wave time point, pulse valley value, and the time point of the first heart sound peak. By calculating the difference between these time points, joint features are obtained, such as pre-ejection period (PEP), pulse transit time, pulse arrival time, the ratio of systolic duration between the pulse signal and heart sound signal, and the ratio of diastolic duration between the pulse signal and heart sound signal. Personal information features are obtained by collecting and analyzing the subject's personal data, including age, height, and weight.

In physiological analysis and disease diagnosis algorithms based on ECG, PPG, and PCG signals, using high-quality segments analyzed by the algorithm for subsequent calculations can greatly improve the accuracy and robustness of the algorithm.

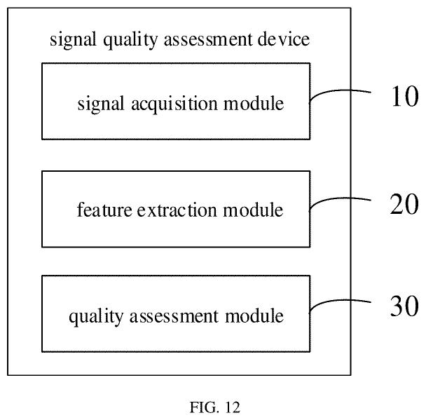

An embodiment of the present application further provides a heart sound signal quality assessment apparatus. As shown in FIG. 12, the apparatus includes a signal acquisition module 10, configured to acquire heart sound signals, a feature extraction module 20 configured to extract features from the heart sound signal to obtain signal features, and a quality assessment module 30 configured to input the signal features into a pre-trained signal quality assessment model and output a signal quality assessment result. The signal features include one or more of local variance features, local peak features, signal energy features, and zero-crossing rate features.

The feature extraction module 20 is further configured to perform sliding window processing on the heart sound signal, take the heart sound signal within the sliding window as a sub-heart sound signal, and for each of the sub-heart sound signals, extract feature on the sub-heart sound signal to obtain a signal feature corresponding to the sub-heart sound signal.

In the case where the signal feature includes a local variance feature, the feature extraction module 20 is further configured to:
perform sliding window processing on the sub-heart sound signal, and take the sub-heart sound signal within the sliding window as a secondary sub-heart sound signal;
determine a signal value standard deviation of each secondary sub-heart sound signal, and take a variance of all the signal value standard deviations as a first variance feature;
take a mean of all the signal value standard deviations as a first mean, and sort all the signal value standard deviations to obtain a standard deviation sequence, wherein the standard deviation sequence includes the signal value standard deviations sorted in descending order based on numerical values;
determine a first preset number of signal value standard deviations in the standard deviation sequence;
take a mean of the first preset number of signal value standard deviations as a second mean, and take a ratio of the first mean to the second mean as a second variance feature;
take a variance of starting sampling point positions of all the windows as a third variance feature; and
take one or more of the first variance feature, the second variance feature, and the third variance feature as the local variance feature.

In the case where the signal feature includes a local peak feature, the feature extraction module 20 is further configured to:
determine a signal peak value of the sub-heart sound signal, and adjust the signal peak value based on a first preset adjustment coefficient to obtain a first threshold, wherein the first threshold is smaller than the signal peak value;
determine a first target signal value greater than the first threshold among signal values of the sub-heart sound signal, and take a sampling point number of signal sampling points corresponding to the first target signal value as a first sampling point number;
adjust the signal peak value based on a second preset adjustment coefficient to obtain a second threshold, wherein the second threshold is smaller than the signal peak value, and the second preset adjustment coefficient is smaller than the first preset adjustment coefficient;
determine a second target signal value smaller than the second threshold among the signal values of the sub-heart sound signal, and take a sampling point number of signal sampling points corresponding to the second target signal value as a second sampling point number; and
take the first sampling point number and/or the second sampling point number as the local peak feature.

In the case where the signal feature includes a signal energy feature, the feature extraction module 20 is further configured to:
perform a Fourier transform on the sub-heart sound signal, and take the sub-heart sound signal after the Fourier transform as a target signal;
determine a signal energy corresponding to each frequency of the target signal, and determine a total signal energy of all the signal energies;
determine a first frequency smaller than a first preset frequency among all frequencies comprised in the target signal, determine the signal energy corresponding to each first frequency, and take the total energy of the signal energies corresponding to all the first frequencies as a low-frequency energy distribution ratio;
determine a second frequency greater than a second preset frequency among all frequencies comprised in the target signal, determine the signal energy corresponding to each second frequency, and take the total energy of the signal energies corresponding to all the second frequencies as a high-frequency energy distribution ratio, wherein the second preset frequency is greater than or equal to the first preset frequency;
input the target signal into a preset logarithmic energy feature extraction model, and output a logarithmic energy; and
take one or more of the total signal energy, the low-frequency energy distribution ratio, the high-frequency energy distribution ratio and the logarithmic energy as signal energy features.

In the case where the signal feature includes a zero-crossing rate feature, the feature extraction module 20 is further configured to:
determine a zero-crossing rate of the sub-heart sound signal in each frame, wherein the zero-crossing rate includes a ratio of a zero-crossing signal sampling point number to a total signal sampling point number of the heart sound signal in one frame;
determine a maximum zero-crossing rate among all the zero-crossing rates, and determine a minimum zero-crossing rate among all the zero-crossing rates;
perform differential processing on all the zero-crossing rates to obtain first-order differential zero-crossing rates;
determine a maximum first-order differential zero-crossing rate among all the first-order differential zero-crossing rates, and determine a variance of all the first-order differential zero-crossing rates;
perform differential processing on all the first-order differential zero-crossing rates to obtain second-order differential zero-crossing rates;
determine a maximum second-order differential zero-crossing rate among all the second-order differential zero-crossing rates, and determine a standard deviation of all the second-order differential zero-crossing rates; and
take one or more of the maximum zero-crossing rate, the minimum zero-crossing rate, the maximum first-order differential zero-crossing rate, the variance of all the first-order differential zero-crossing rates, the maximum second-order differential zero-crossing rate and the standard deviation of all the second-order differential zero-crossing rates as zero-crossing rate features.

The quality assessment module 30 is further configured to input the signal feature corresponding to each the sub-heart sound signal into the pre-trained signal quality assessment model, and output a signal quality assessment result of each sub-heart sound signal.

The apparatus further includes a pre-processing module. The pre-processing module is configured to:
perform signal filtering processing on the heart sound signal to obtain a filtered heart sound signal, wherein the signal filtering includes a zero-phase-shift Butterworth filter;
perform signal clipping processing on the filtered heart sound signal to obtain a preprocessed heart sound signal, where the signal clipping includes clipping a head end of heart sound signal with a preset time length and/or clipping a tail end of heart sound signal with a preset time length; and
extract the feature from the heart sound signal to obtain the signal feature based on the preprocessed heart sound signal.

The heart sound signal quality assessment apparatus provided by the present application, employing the heart sound signal quality assessment method described in the above embodiments, can address the technical problem of effectively assessing the signal quality of heart sound signals. Compared to the related art, the heart sound signal quality assessment apparatus provided by the embodiments of the present application achieves the same beneficial effects as the heart sound signal quality assessment method provided by the aforementioned embodiments. Other technical features of the heart sound signal quality assessment apparatus are the same as those disclosed in the aforementioned embodiments and are not further elaborated here.

An embodiment of the present application provides an electronic device, including at least one processor and a memory communicatively connected to the at least one processor. The memory stores instructions executable by the at least one processor, and the instructions are executed by the at least one processor so that the at least one processor can execute the heart sound signal quality assessment method of the above-mentioned embodiments.

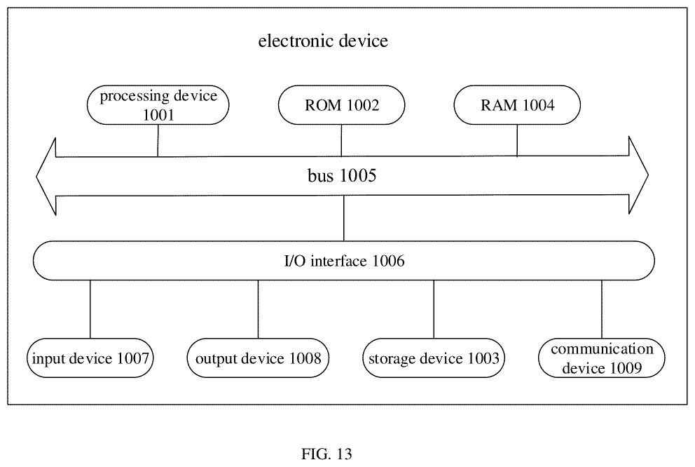

As shown in FIG. 13, which illustrates a schematic diagram of an electronic device suitable for implementing embodiments of the present application. The electronic device in the embodiments of the present application may be a portable device, etc. The electronic device illustrated in FIG. 13 is merely an example and should not limit the functionality or scope of use of the embodiments of the present application.

As shown in FIG. 13, the electronic device may include a processing device 1001 (e.g., a central processing unit, a graphics processing unit, etc.), which can perform various appropriate actions and processes based on programs stored in a read-only memory (ROM) 1002 or programs loaded from a storage device into a random access memory (RAM) 1004. RAM 1004 also stores various programs and data required for the operation of the electronic device. Processing device 1001, ROM 1002, and RAM 1004 are interconnected via a bus 1005. An input/output (I/O) interface is also connected to bus 1005.

Typically, the following systems may be connected to I/O interface 1006: input device 1007 including, for example, a touch screen, touchpad, keyboard, mouse, image sensor, microphone, accelerometer, gyroscope, etc., output device 1008 including, for example, a liquid crystal display (LCD), speaker, vibrator, etc., storage device 1003 including, for example, a magnetic tape, hard disk, etc., and communication device 1009. Communication device 1009 may allow the electronic device to communicate with other devices wirelessly or by wire to exchange data. Although the figure shows an electronic device with various systems, it should be understood that not all of the illustrated systems are required to be implemented or present. More or fewer systems may alternatively be implemented or present.

In particular, according to an embodiment of the present application, the process described above with reference to the flowchart can be implemented as a computer software program. For example, an embodiment of the present application includes a computer program product, which includes a computer program carried on a computer-readable medium, and the computer program includes program code for executing the method shown in the flowchart. In such an embodiment, the computer program can be downloaded and installed from a network via a communication device 1009, or installed from a storage device 1003, or installed from a ROM 1002. When the computer program is executed by the processing device 1001, the above-mentioned functions defined in the method of the embodiment of the present application are performed.

The electronic device provided by the present application, employing the heart sound signal quality assessment method described in the above-mentioned embodiment, can solve the technical problem of effectively assessing the signal quality of heart sound signals. Compared to the related art, the electronic device provided by the present application achieves the same beneficial effects as the heart sound signal quality assessment method described in the above-mentioned embodiment. Other technical features of the electronic device are the same as those disclosed in the above-mentioned embodiment and are not further elaborated here.

It should be understood that various parts of the present application can be implemented with hardware, software, firmware or a combination thereof. In the description of the above embodiments, specific features, structures, materials or characteristics can be combined in any one or more embodiments or examples in an appropriate manner.

The above description is merely a specific embodiment of the present application, but the scope of the present application is not limited thereto. Any modifications or substitutions that can be easily conceived by those skilled in the art within the technical scope disclosed in the present application should be included in the scope of the present application. Therefore, the scope of the present application should be based on the scope of the claims.

An embodiment of the present application provides a computer-readable storage medium having computer-readable program instructions stored thereon, and the computer-readable program instructions are used to execute the heart sound signal quality assessment method in the above-mentioned embodiments.

The computer-readable storage medium provided in the embodiments of the present application may be, for example, a USB flash drive, but is not limited to electrical, magnetic, optical, electromagnetic, infrared, or semiconductor systems or devices, or any combination thereof. More specific examples of computer-readable storage media may include, but are not limited to, an electrical connection having one or more wires, a portable computer disk, a hard disk, RAM, ROM, erasable programmable read-only memory (EPROM or flash memory), optical fiber, a portable compact disk read-only memory (CD-ROM), an optical storage device, a magnetic storage device, or any suitable combination thereof. In this embodiment, the computer-readable storage medium may be any tangible medium that contains or stores a program that can be used by or in conjunction with an instruction execution system or device. The program code contained on the computer-readable storage medium may be transmitted using any suitable medium, including but not limited to wires, optical cables, radio frequency (RF), etc., or any suitable combination thereof.

The computer-readable storage medium may be included in the electronic device, or may exist independently without being incorporated into the electronic device.

The computer-readable storage medium carries one or more programs. When executed by an electronic device, the one or more programs cause the electronic device to: collect heart sound signals; extract features from the heart sound signals to obtain signal features, wherein the signal features include one or more of local variance features, local peak features, signal energy features, and zero-crossing rate features; and input the signal features into a pre-trained signal quality assessment model to output a signal quality assessment result. The computer program code for performing the operations of the present application can be written in one or more programming languages, or a combination thereof. The programming languages include object-oriented programming languages such as Java, Smalltalk, and C++, as well as conventional procedural programming languages such as “C” or similar programming languages. The program code can be executed entirely on the user's computer, partially on the user's computer, as a standalone software package, partially on the user's computer and partially on a remote computer, or entirely on a remote computer or server. Where a remote computer is involved, the remote computer may be connected to the user's computer through any type of network, including a local area network (LAN) or a wide area network (WAN), or it may be connected to an external computer (such as through the Internet using an Internet service provider).

The flow charts and block diagrams in the accompanying drawings illustrate the possible implementation architecture, functions and operations of the system, method and computer program product according to various embodiments of the present application. In this regard, each box in the flow chart or block diagram can represent a module, program segment, or a part of code, and the module, program segment, or a part of code contains one or more executable instructions for realizing the specified logical function. It should also be noted that in some alternative implementations, the functions marked in the box can also occur in a different order than that marked in the accompanying drawings. For example, two boxes represented in succession can actually be executed substantially in parallel, and they can sometimes be executed in the opposite order, depending on the functions involved. It should also be noted that each box in the block diagram and/or flow chart, and the combination of the boxes in the block diagram and/or flow chart, can be implemented with a dedicated hardware-based system that performs the specified function or operation, or can be implemented with a combination of dedicated hardware and computer instructions.

The modules involved in the embodiments described in the present application may be implemented in software or hardware, wherein the name of a module does not necessarily limit the unit itself.

The computer-readable storage medium provided by the present application stores computer-readable program instructions for executing the aforementioned heart sound signal quality assessment method, thereby solving the technical problem of effectively assessing the signal quality of heart sound signals. Compared to the related art, the beneficial effects of the computer-readable storage medium provided by the embodiments of the present application are similar to those of the heart sound signal quality assessment methods provided by the aforementioned embodiments and are not further elaborated here.

An embodiment of the present application further provides a computer program product, including a computer program, which implements the steps of the above-mentioned heart sound signal quality assessment method when executed by a processor.

The computer program product provided in the present application can solve the technical problem of effectively assessing the signal quality of heart sound signals. Compared to the related art, the computer program product provided in this embodiment of the present application offers the same beneficial effects as the heart sound signal quality assessment methods provided in embodiments above, and will not be further elaborated here.

The above are only some embodiments of the present application and do not limit the patent scope of the present application. Any equivalent structure or equivalent process transformation made using the contents of the present application specification and drawings, or directly or indirectly applied in other related technical fields, are also included in the patent processing scope of the present application.

What is claimed is:

1. A heart sound signal quality assessment method, comprising:
acquiring a heart sound signal;
extracting a feature from the heart sound signal to obtain a signal feature, wherein the signal feature comprises one or more of a local variance feature, a local peak feature, a signal energy feature, and a zero-crossing rate feature; and
inputting the signal feature into a pre-trained signal quality assessment model, and outputting a signal quality assessment result.

2. The heart sound signal quality assessment method according to claim 1, wherein the extracting feature from the heart sound signal to obtain the signal feature comprises:
performing sliding window processing on the heart sound signal, and taking the heart sound signal within the sliding window as a sub-heart sound signal; and
for each sub-heart sound signal, extracting a feature from the sub-heart sound signal to obtain a signal feature corresponding to the sub-heart sound signal.

3. The heart sound signal quality assessment method according to claim 2, wherein in response to that the signal feature comprises the local variance feature, the extracting the feature from the sub-heart sound signal to obtain the signal feature corresponding to the sub-heart sound signal comprises:
performing sliding window processing on the sub-heart sound signal, and taking the sub-heart sound signal within the sliding window as a secondary sub-heart sound signal;
determining a signal value standard deviation of each secondary sub-heart sound signal, and taking a variance of all the signal value standard deviations as a first variance feature;
taking a mean of all the signal value standard deviations as a first mean, and sorting all the signal value standard deviations to obtain a standard deviation sequence, wherein the standard deviation sequence comprises the signal value standard deviations sorted in descending order based on numerical values;
determining a first preset number of signal value standard deviations in the standard deviation sequence;
taking a mean of the first preset number of signal value standard deviations as a second mean, and taking a ratio of the first mean to the second mean as a second variance feature;
taking a variance of starting sampling point positions of all the windows as a third variance feature; and
taking one or more of the first variance feature, the second variance feature, and the third variance feature as the local variance feature.

4. The heart sound signal quality assessment method according to claim 2, wherein in response to that the signal feature comprises the local peak feature, the extracting the feature from the sub-heart sound signal to obtain the signal feature corresponding to the sub-heart sound signal comprises:
determining a signal peak value of the sub-heart sound signal, and adjusting the signal peak value based on a first preset adjustment coefficient to obtain a first threshold, wherein the first threshold is smaller than the signal peak value;
determining a first target signal value greater than the first threshold among signal values of the sub-heart sound signal, and taking a sampling point number of signal sampling points corresponding to the first target signal value as a first sampling point number;
adjusting the signal peak value based on a second preset adjustment coefficient to obtain a second threshold, wherein the second threshold is smaller than the signal peak value, and the second preset adjustment coefficient is smaller than the first preset adjustment coefficient;
determining a second target signal value smaller than the second threshold among the signal values of the sub-heart sound signal, and taking a sampling point number of signal sampling points corresponding to the second target signal value as a second sampling point number; and
taking the first sampling point number and/or the second sampling point number as the local peak feature.

5. The heart sound signal quality assessment method according to claim 2, wherein in response to that the signal feature comprises the signal energy feature, the extracting the feature from the sub-heart sound signal to obtain the signal feature corresponding to the sub-heart sound signal comprises:
performing a Fourier transform on the sub-heart sound signal, and taking the sub-heart sound signal after the Fourier transform as a target signal;
determining a signal energy corresponding to each frequency of the target signal, and determining a total signal energy of all the signal energies;
determining a first frequency smaller than a first preset frequency among all frequencies comprised in the target signal, determining the signal energy corresponding to each first frequency, and taking the total energy of the signal energies corresponding to all the first frequencies as a low-frequency energy distribution ratio;
determining a second frequency greater than a second preset frequency among all frequencies comprised in the target signal, determining the signal energy corresponding to each second frequency, and taking the total energy of the signal energies corresponding to all the second frequencies as a high-frequency energy distribution ratio, wherein the second preset frequency is greater than or equal to the first preset frequency;
inputting the target signal into a preset logarithmic energy feature extraction model, and outputting a logarithmic energy; and
taking one or more of the total signal energy, the low-frequency energy distribution ratio, the high-frequency energy distribution ratio and the logarithmic energy as signal energy feature.

6. The heart sound signal quality assessment method according to claim 2, wherein in response to that the signal feature comprises the zero-crossing rate feature, the extracting the feature from the sub-heart sound signal to obtain the signal feature corresponding to the sub-heart sound signal comprises:
determining a zero-crossing rate of the sub-heart sound signal in each frame, wherein the zero-crossing rate comprises a ratio of a zero-crossing signal sampling point number to a total signal sampling point number of the heart sound signal in one frame;
determining a maximum zero-crossing rate among all the zero-crossing rates, and determining a minimum zero-crossing rate among all the zero-crossing rates;
performing differential processing on all the zero-crossing rates to obtain first-order differential zero-crossing rates;
determining a maximum first-order differential zero-crossing rate among all the first-order differential zero-crossing rates, and determining a variance of all the first-order differential zero-crossing rates;
performing differential processing on all the first-order differential zero-crossing rates to obtain second-order differential zero-crossing rates;
determining a maximum second-order differential zero-crossing rate among all the second-order differential zero-crossing rates, and determining a standard deviation of all the second-order differential zero-crossing rates; and
taking one or more of the maximum zero-crossing rate, the minimum zero-crossing rate, the maximum first-order differential zero-crossing rate, the variance of all the first-order differential zero-crossing rates, the maximum second-order differential zero-crossing rate and the standard deviation of all the second-order differential zero-crossing rates as zero-crossing rate feature.

7. The heart sound signal quality assessment method according to claim 2, wherein the inputting the signal feature into the pre-trained signal quality assessment model, and outputting the signal quality assessment result comprises:
inputting the signal feature corresponding to each the sub-heart sound signal into the pre-trained signal quality assessment model, and outputting a signal quality assessment result of each sub-heart sound signal.

8. The heart sound signal quality assessment method according to claim 1, wherein before the extracting the feature from the heart sound signal to obtain the signal feature, the method further comprises:
performing signal filtering processing on the heart sound signal to obtain a filtered heart sound signal, wherein the signal filtering comprises a zero-phase-shift Butterworth filter;
performing signal clipping processing on the filtered heart sound signal to obtain a preprocessed heart sound signal, wherein the signal clipping comprises clipping a head end of heart sound signal with a preset time length and/or a preset time length of a tail end of heart sound signal with a preset time length; and
extracting the feature from the heart sound signal to obtain the signal feature based on the preprocessed heart sound signal.

9. An electronic device, comprising:
at least one processor; and,
a memory communicatively connected to the at least one processor,
wherein the memory stores instructions executable by the at least one processor, and the instructions are executed by the at least one processor to enable the at least one processor to perform the steps of the heart sound signal quality assessment method according to claim 1.

10. A non-transitory computer-readable storage medium, wherein the non-transitory computer-readable storage medium stores a program for implementing a heart sound signal quality assessment method, and the program for implementing the heart sound signal quality assessment method is executed by a processor to implement the steps of the heart sound signal quality assessment method according to claim 1.
